(19) United States
(12) Patent Application Publication
(10) Pub. No.: US 2024/0280473 A1
(43) Pub. Date: Aug. 22, 2024

(54) PHOTOLUMINESCENT IMAGING OF SEMICONDUCTOR SAMPLES

(71) Applicants: Zoltán Tamás KISS, Budapest (HU); Máté NAGY, Dunaszentpál (HU); Zsombor ANTAL, Kecskemét (HU); László DUDÁS, Budapest (HU); György NÁDUDVARI, Pilisszentiván (HU)

(72) Inventors: Zoltán Tamás KISS, Budapest (HU); Máté NAGY, Dunaszentpál (HU); Zsombor ANTAL, Kecskemét (HU); László DUDÁS, Budapest (HU); György NÁDUDVARI, Pilisszentiván (HU)

(21) Appl. No.: 18/583,597

(22) Filed: Feb. 21, 2024

(30) Foreign Application Priority Data
Feb. 22, 2023 (HU) P2300063

(51) Int. Cl. G01N 21/17; G01N 21/19; G01N 21/31; G01N 21/86

(52) U.S. Cl. CPC G01N 21/17; G01N 21/19; G01N 2021/3181; G01N 2021/8636

(57) ABSTRACT

A method and apparatus for photoluminescent imaging of a sample are disclosed.

### FIELD OF THE INVENTION

The present invention relates to a method and apparatus for photoluminescent imaging of semiconductor samples, and more specifically for high-resolution and high speed photoluminescent imaging of the whole surface semiconductor wafers used for manufacturing semiconductor devices, such as microchips or memory cells.

### BACKGROUND

Photoluminescent imaging is a well-known method for inspecting semiconductor samples, i.e., for detecting defects on the surface or within the material of the wafers. There are numerous commercially available systems for photoluminescent inspection of wafers. Imaging may be performed by using a 2D array of photodetectors, such as a CCD (charge coupled device) camera, or via a scanning method, e.g., by illuminating the wafer in a single line and imaging the illuminated area by a line scan camera that has a linear array of detector pixels.

Existing techniques include imaging arrangements both for 2D area imaging and for line-scan imaging. For example, a line-scanning solutions with an illumination line with a length of 156 mm and a width of 165 μm have been disclosed, wherein the illumination line is produced from a collimated light beam of a laser by a pair of cylindrical lenses. This configuration produces an illumination line with approximately Gaussian intensity distribution along the line.

A non-uniform illumination intensity distribution can result in non-uniform photoluminescent intensity distribution that can be corrected via calibration only to a limited extent, e.g., if the illumination is strong enough along the whole line to produce a measurable amount of photoluminescent light but not strong enough to reach a saturation threshold or to damage the sample. Therefore, non-uniform illumination intensity may be suitable for relatively low resolutions and for samples with relatively strong photoluminescent response, e.g., wafers used for producing photovoltaic cells.

However, certain kind of materials among intrinsic, extrinsic, and compound semiconductors produce much weaker photoluminescent response, and therefore photoluminescent imaging of these materials may need much higher illumination intensity. Such materials are often used for manufacturing microelectronic devices, such as microchips or memory units. Inspection of such wafers also requires higher resolution—by about ten times—that further increases the necessary illumination intensity if scanning time per unit area is to be maintained. Therefore, high resolution and high-speed scanning of wafers used for manufacturing microscopic semiconductor devices may need illumination intensity of several kW/cm². At such high intensities, care should be taken not to exceed the damage threshold of the sample, therefore it is important to provide a uniform intensity profile and avoid intensity spikes along the illumination line.

### SUMMARY

Increasing resolution while maintaining scanning speed (i.e., relative velocity of the illumination line and the sample surface) of a line scanning system may be achieved by focusing the same illumination power to a smaller area while accommodating the imaging system accordingly to image the close vicinity of the illuminated area and reducing exposure time, i.e., increasing the readout frequency of the detector. The limit of this improvement can be the maximal intensity that the sample can endure without damage and without saturation. Therefore, for a given line width and for the maximal safe intensity, the only way to reduce the time required for acquiring a full map of a sample is to increase the length of the scanning line. At the same time, the apparatus should be as compact as possible, e.g., fitting inside a space of 625 mm×900 mm×265 mm, while its cost should also remain reasonable.

In light of the foregoing, the disclosed technology can eliminate or at least ameliorate the drawbacks of the prior solutions. More specifically, methods and apparatus are described for high-resolution and high speed photoluminescent imaging of semiconductor wafers used in the manufacturing of semiconductor devices, such as microchips or memory cells.

### BRIEF DESCRIPTION OF THE DRAWINGS

In what follows, example apparatus and the operation thereof are described in detail with reference to the attached drawing, where:

FIG. 1 shows a simplified functional schematic of an exemplary embodiment of the apparatus;

FIG. 2 shows a simplified functional schematic of a preferred exemplary embodiment of the apparatus;

FIG. 3A shows the optical arrangement of one of the illumination branches of the apparatus from the side; and

FIG. 3B shows the optical arrangement of a portion of the same illumination branch as FIG. 3A, from the top.

### DETAILED DESCRIPTION

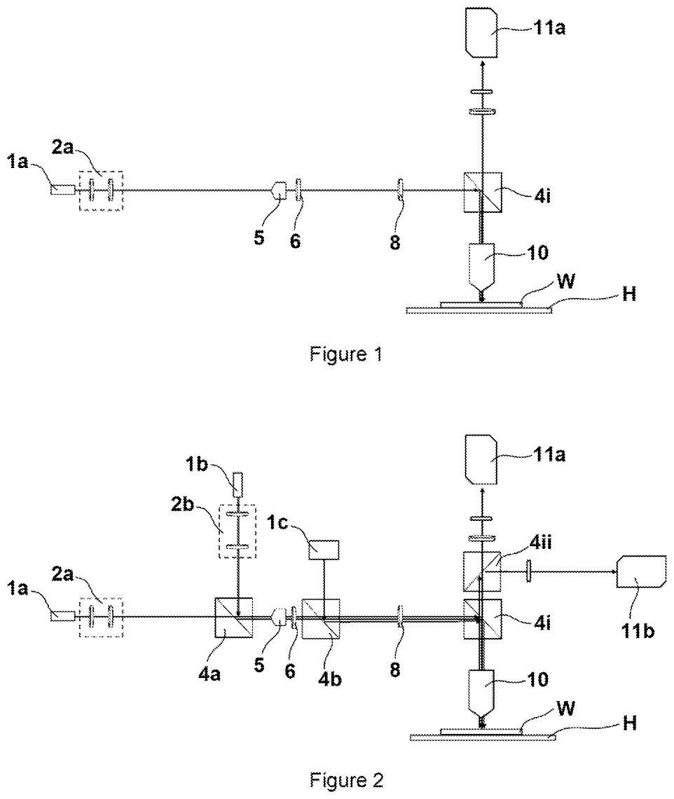

FIG. 1 shows a simplified functional schematic of an example apparatus. The apparatus includes a sample holder H for holding a sample W to be examined. The sample W is preferably a whole wafer, and accordingly the sample holder H is a wafer holder. Alternatively, the sample may be for example a semiconductor ingot, a piece of a wafer, e.g., a half wafer, or a smaller, broken piece of wafer.

The apparatus further includes a movement mechanism for causing relative movement of said sample W and one or more optical components of the apparatus. The movement mechanism can include, for example, a movable stage for moving said sample holder H relative to the rest of the apparatus. The apparatus includes a first light source 1a that is preferably a narrow band light source, e.g., a laser, e.g., a single-mode laser that operates on a wavelength suitable for exciting the material of sample to produce photoluminescence, e.g., fluorescence or phosphorescence. In some examples, said first light source 1a has an emission wavelength of any one of the group including 532 nm, 808 nm and 976 nm. Said first light source 1a can be a fiber-coupled laser. The first light source 1a can produce a first light beam, having a circular beam profile and an approximately Gaussian intensity distribution. In the following, a path of the first light beam from the first light source 1a to the sample W is referred to as a first illumination light path.

The first light beam emitted from the first light source 1a is guided through a first symmetric beam expander 2a to a line generator 5. The first symmetric beam expander 2a produces a symmetrically expanded first light beam, i.e., a light beam that have a circular beam profile, a Gaussian intensity distribution, and a diameter different from the diameter of the first light beam. The diameter of the expanded light beam is adjusted according to optimal beam input parameters of the line generator 5. In the present specification, the term ‘circular beam profile’ is used in the meaning that—in a plane perpendicular to a propagation direction of said beam—the beam is bounded by a circle and the inside of the circle is also lit. The boundary of the beam is the portion of the beam, where the light intensity is 1/e² part (about 13.5%) of the intensity maximum, where e is Euler's number.

Said first symmetric beam expander 2a can include two plano-convex lenses and a double concave lens arranged between the plano-convex lenses, wherein convex and concave surfaces of said lenses preferably have a cylindrical symmetry, e.g., said surfaces may be spherical, paraboloid or hyperboloid surfaces. The extent of the expansion may be adjusted by moving one or more optical elements of the first symmetric beam expander 2a along the optical axis. Depending on the parameters of the beam emitted by the light source—and its collimator—and the selected line generator, the expansion may be negative, i.e., the beam output from the beam expander 2a may have a diameter less than that of the input beam. In the present specification, the beam exiting the beam expander is an expanded beam, regardless of the sign of the expansion, and accordingly, the term “expansion” may mean either an increase or a reduction of the diameter of a collimated light beam.

Said symmetrically expanded first light beam is guided onto a line generator 5 for shaping the light beam to a linear shape that has an approximately uniform intensity distribution along the line, i.e., a so-called ‘flat top’ or ‘top hat’ beam profile. As said line has a thickness that is larger than zero, it may be considered a rectangle with the length of the shorter side of the rectangle being equal to the thickness or width of said line, while the longer side of the rectangle being equal to the length of the line. Accordingly, the line generator 5 increases the size of an incoming circular beam in a first direction that is the length of the line, while not changing the size of the beam in a second direction perpendicular to the first direction, i.e., the size of the beam in the second direction, that is, the width of the line, will be equal to the incoming beam diameter. The line generator 5 can be formed by a Powell lens, that—with an accurate adjustment of the optical system-allows producing a line with uniform intensity distribution in a more reliable and repeatable manner when compared with line generators with micro-features. The light exiting the line generator 5 is diverging along a first axis perpendicular to the propagation direction and remains collimated along a second axis that is perpendicular to both the first axis and to the propagation direction. The first and second axes are defined by the line generator 5. A collimator 6, e.g., a focusing lens, is arranged after the line generator 5 to collimate the light beam along said first axis, while focusing it along the second axis.

It has been discovered that imaging aberrations for light rays farther away from the optical axis can be significantly reduced. For example, the collimator 6 can be formed by two lenses instead of one, preferably plano-convex lenses that are arranged so that their planar surfaces face toward the line generator 5 and their convex surfaces face in the direction of the propagation of light.

The beam exiting the collimator 6, collimated along the first axis and focused along the second axis could be guided onto the sample W through an objective 10 to produce an illuminating line. This solution is known and follows the general design principle, applied during design of most optical systems, of minimizing light loss by minimizing the number of interacting optical elements. Said objective 10 focuses the light beam along the first axis to a first position and along the second axis to a second position, that is either closer to the or farther from the objective 10 than the first position, depending on the distance between the objective 10 and the collimator 6 and their respective focal lengths. In this arrangement the sample is placed into the second position, where the beam is defocused along the first axis and thus it illuminates the sample along a line that has a uniform intensity distribution due to the effect of the line generator 5. This setup can produce an illumination line with a width of about 10-20 μm, but a length of only about 1.0-1.5 mm. Such an illumination is suitable for scanning a single line of the sample that is sufficient if only a partial sampling is required, but creating a full map of a wafer surface with such an illumination would take a long time, because numerous strips would have to be scanned, for example in the case of a wafer of 150 mm diameter, 100-150 strips are required. Accordingly, it can be advantageous to use a longer illumination line to reduce the time required for mapping the whole surface of a wafer.

It has been discovered, that arranging a field lens 8 between the collimator 6 and the objective 10 so that the focus plane of the field lens 8 coincides with that of the collimator 6, the field lens 8 may serve an unusual double purpose. From one hand, it functions as a beam expander together with the collimator 6 along the second axis and thus allows illumination of a larger portion, preferably the entirety of the entry pupil of the objective 10 along the second axis, allowing the creation of a tighter focus spot along the second axis, i.e., a thinner line, down to the diffraction limit of the objective 10 at the illumination wavelength. From the other hand, it focuses the beam along the first axis preferably to the rear focal plane of the objective 10 and thus the objective 10 collimates the beam along the first axis, effectively working as a beam expander together with the field lens 8 along said first axis, providing a line length that is increased according to the magnification of the objective. With other words, using a suitably selected field lens 8 in the inventive arrangement between the collimator 6 and the objective 10 allows producing an illumination line with a width that is near the diffraction limit of the optics, while having a significantly larger length and ultimately allowing a faster scanning per unit area or more specifically, a faster scanning of the entire surface of the wafer without sacrificing resolution. In the above explanation, the first and second axes are to be considered in relation to the light beam, and thus when the propagation direction of the light beam is changed, a corresponding transformation of said axes is necessary.

In conclusion, the apparatus is capable of producing a relatively long and thin illumination line with uniform intensity distribution due to its unique beam shaping optics formed by the arrangement of the line generator 5, the collimator 6, the field lens 8 and the objective 10.

The apparatus further includes a first camera 11a for detecting photoluminescent light that is emitted by the sample W and collected by the objective 10. The first camera 11a includes at least one line of photodetector pixels, preferably exactly one line of photodetector pixels. The photodetector pixels are preferably selected to be responsive at the wavelength of the photoluminescence emitted by the sample W to be inspected. For example, the photodetector pixels may be conventional silicon-based CCD pixels or more preferably formed by InGaAs-based photodiodes. In the following, a path of the photoluminescent light from the sample W to the first camera 11a is referred to as a first imaging light path.

The apparatus can include a first imaging dichroic optical element 4i for directing the first light beam toward the objective 10 and thus toward the sample W and for directing photoluminescent light emitted by the sample W toward the first camera 11a. The first imaging dichroic optical element 4i can be formed by a long-pass dichroic plate and arranged so that it reflects most of the intensity of the sorter wavelength illumination light and transmits longer wavelength photoluminescent light. Such an arrangement is shown in the figures. Alternatively, the first imaging dichroic optical element 4i can be formed by a short-pass dichroic plate arranged so that the illumination light passes through, while the photoluminescent light is reflected toward the first camera 11a.

Note that FIG. 1 illustrates only a general arrangement of an example of the optical system, not their actual orientations and distances. In an actual setup, some of the components can be arranged in different planes than the others and accordingly, the apparatus can include several further mirrors and/or other optical elements to guide the light beams on their respective light paths.

In each Figure, the same reference numbers indicate the same parts.

FIG. 2 shows a simplified functional schematic of an example of the apparatus. According to this example, the apparatus includes a first light source 1a and a second light source 1b. The first light source 1a and said second light source 1b can be narrow band light sources, e.g., lasers, e.g., single-mode lasers of different wavelengths for exciting the sample W to produce photoluminescence, i.e., fluorescence or phosphorescence. An advantage of having more than one light source is that a wider variety of samples W may be investigated by the apparatus, since different materials may be responsive to different excitation wavelengths. In the following, a path of the second light beam from the second light source 1b to the sample W is referred to as a second illumination light path.

In some examples, said first light source 1a and said second light source 1b are lasers with emission wavelengths selected from the group comprising 532 nm, 808 nm and 976 nm, preferably 532 and 808 nm. The first light source 1a and the second light source 1b can be fiber-coupled lasers. The first light source 1a and the second light source 2b can produce a first light beam and a second light beam of circular beam profiles, both having Gaussian intensity distribution.

The first light beam emitted from the first light source 1a is guided through a first symmetric beam expander 2a, preferably including two plano-convex lenses and a double concave lens. The second light beam emitted by the second light source 1b is guided through a second beam expander 2b preferably including two plano-convex lenses and a double concave lens.

A first illumination dichroic optical element 4a is arranged in the light paths of the first light beam and the second light beam so that the first illumination dichroic optical element 4a reflects one of the first light beam and the second light beam and transmits the other one of the first light beam and the second light beam such that the first and second light beams coincide after leaving the first illumination dichroic optical element 4a. The first illumination dichroic optical element 4a can be a dichroic plate or a dichroic cube.

Along the light path of the first and second light beams, after the first illumination dichroic optical element 4a, i.e., at a location where the first and second collimated light beams coincide, a line generator 5, is arranged to shape the light beams to a linear shape that has an approximately uniform intensity distribution along the line, e.g., a so-called ‘flat top’ or ‘top hat’ beam profile. The line generator 5 can be formed by a Powell lens, that—with an accurate adjustment of the optical system-allows producing a line with uniform intensity distribution in a more reliable and repeatable manner when compared with line generators with micro-features. The light exiting the line generator 5 is diverging along a first axis perpendicular to the propagation direction and remains collimated along a second axis that is perpendicular to both the first axis and to the propagation direction. The first and second axes are defined by the line generator 5. A collimator 6, e.g., a focusing lens, is arranged after the line generator 5 to collimate the light beam along the first axis, while focusing it along the second axis.

It has been discovered that imaging aberrations for light rays farther away from the optical axis can be reduced if the collimator 6 is formed by two lenses instead of one, more specifically two achromatic lenses, e.g., plano-convex achromatic lenses, e.g., that are arranged so that their planar surfaces face toward the line generator 5 and their convex surfaces face in the direction of the propagation of light.

The beams exiting the collimator 6, collimated along the first axis and focused along the second axis could be guided onto the sample through an objective 10 to produce an illuminating line. This solution follows the general design principle, applied during design of most optical systems, of minimizing light loss by minimizing the number of interacting optical elements. Said objective 10 would focus the light beam along the first axis to a first position and along the second axis to a second position, that is either closer to the or farther from the objective 10 than the first position, depending on the distance between the objective 10 and the collimator 6 and their respective focal lengths. In this arrangement the sample is placed into the second position, where the beam is defocused along the first axis and thus it will illuminate the sample along a line that has a uniform intensity distribution due to the effect of the line generator 5. This setup can produce an illumination line with a width of about 10-20 μm, but a length of only about 1.0-1.5 mm. Such an illumination is suitable for scanning a single line of the sample, but creating a full map of a wafer surface with such an illumination would take a long time, because numerous strips would have to be scanned, for example in the case of a wafer of 150 mm diameter, 100-150 strips are required. Accordingly, it can be advantageous to use a longer illumination line to reduce the time required for mapping the whole surface of a wafer.

It has been discovered, that arranging a field lens 8 between the collimator 6 and the objective 10 so that the focus plane of the field lens 8 coincides with that of the collimator 6, the field lens 8 may serve an unusual double purpose. From one hand, it functions as a beam expander together with the collimator 6 along the second axis and thus allows illumination of a larger portion, preferably the entirety of the entry pupil of the objective 10 along the second axis, allowing the creation of a tighter focus spot along the second axis, i.e., a thinner line, down to the diffraction limit of the objective 10 at the illumination wavelength. From the other hand, it focuses the beam along the first axis preferably to the rear focal plane of the objective 10 and thus the objective 10 collimates the beam along the first axis, effectively working as a beam expander together with the field lens 8 along said first axis, providing a line length that is increased according to the magnification of the objective. With other words, using a suitably selected field lens 8 between the collimator 6 and the objective 10 allows producing an illumination line with a width that is near the diffraction limit of the optics, while having a significantly larger length and ultimately allowing a faster scanning per unit area or more specifically, a faster scanning of the entire surface of the wafer without sacrificing resolution. In the above explanation, the first and second axes are to be considered in relation to the light beam, and thus when the propagation direction of the light beam is changed, a corresponding transformation of said axes is necessary.

In conclusion, the apparatus is capable of producing a relatively long and thin illumination line with uniform intensity distribution due to its unique beam shaping optics formed by the arrangement of the line generator 5, the collimator 6, the field lens 8 and the objective 10.

The apparatus can include a first imaging dichroic optical element 4i for directing the first light beam and the second light beam toward the objective 10 and thus toward the wafer W and for directing photoluminescent light emitted by the sample W toward the first camera 11a. The first imaging dichroic optical element 4i may be formed by a long-pass dichroic plate and arranged so that most of the sorter wavelength illumination light is reflected by the first imaging dichroic optical element 4i, while longer wavelength photoluminescent light passes through the first imaging dichroic optical element 4i. This example is shown in the figures. Alternatively, the first imaging dichroic optical element 4i may be formed by a short-pass dichroic plate arranged so that the illumination light passes through, while the photoluminescent light is reflected toward the first camera 11a.

In some examples, the apparatus further includes a third light source 1c for emitting a third light beam, a second illumination dichroic optical element 4b for coupling the third light beam into the common light path of the first and second light beams, and a second imaging dichroic optical element 4ii for directing the light of the third light source that is reflected from the sample W toward a second camera 11b. The third light source 1c is preferably a light emitting diode for emitting light in a portion of the visible wavelength range, e.g., 485-525 nm. In the following, a path of the third light beam from the third light source 1c to the sample W is referred to as a third illumination light path. The second camera 11b is suitable for detecting light at the operation wavelength of the third light source 1c and thus for capturing a reflection image of the sample, e.g., for identifying certain kind of defects, like scratches or dust particles. For example, the second camera 11b may be a conventional CCD camera, preferably line scan camera having only a single linear array of CCD pixels. In the following, a path of the reflected light from the sample W to the second camera 11a is referred to as a second imaging light path.

The apparatus can include a further collimator (not shown in the Figures) for collimating the light of the third light source 1c, said collimator is preferably integrated with the third light source 1c. In certain examples, a slit is arranged in the light path of the collimated light beam of the third light source 1c, the second illumination dichroic optical element 4b is preferably arranged between the collimator 6 and the field lens 8 in the light path of the first and second light beams, and between the slit and the field lens 8 in the light path of the third light beam, and ultimately said slit that is uniformly illuminated is imaged onto the sample W by the field lens 8 and the objective 10 thus creating a uniformly lit third line. Thickness of the third line is generally not an issue, because reflection imaging does not generally require such high illumination intensity as photoluminescent imaging.

In some examples, the second imaging dichroic optical element 4ii is formed by a long-pass dichroic plate so that the photoluminescent light passes through toward the first camera 11a and the light of the third light source 1c that is reflected from the sample W is reflected toward a second camera 11b. The first imaging dichroic optical element 4i is preferably selected so that it does not completely reflect light at the wavelength of the third light source 1c, e.g., it has a reflection of about 0.9 at said wavelength, meaning that it reflects 90% percent of light on said wavelength, and transmitting the rest. Reflection imaging does not suffer from the very low efficiency of exciting photoluminescent light, and thus even as much as 90% light loss is tolerable either within an illumination light path or an imaging light path of the third light beam. For example, the configuration shown in FIG. 2 results in high light loss in the reflection imaging light path as most of the light reflected by the sample W is reflected by the first imaging dichroic optical element 4i toward the light sources and only a smaller portion of said light is passed through toward the second imaging dichroic optical element 4ii and toward the second camera 11b.

The third light beam is guided onto the surface of the sample W through the same light path as that of the first and second light beams so that the third light source illuminates the sample W in the vicinity of the first and second light beams. This is suitable for investigating the sample in reflected light. Optionally, a slit may be selectively insertable into the light path between the collimator of the third light source and the second illumination dichroic optical element 4b. Insertion and removal of said slit into and from the light path allows switching between line illumination for scanning and illuminating the whole field of view of the objective 10 that may be suitable for taking 2D images of the whole view field of the objective, especially when the second camera 11b is a 2D camera.

Note that FIG. 2 illustrates only a general arrangement of an example of the optical system, not their actual orientations and distances. In an actual setup, some of the components can be arranged in different planes than the others and accordingly, the apparatus can include several further mirrors and/or other optical elements to guide the light beams on their respective light paths.

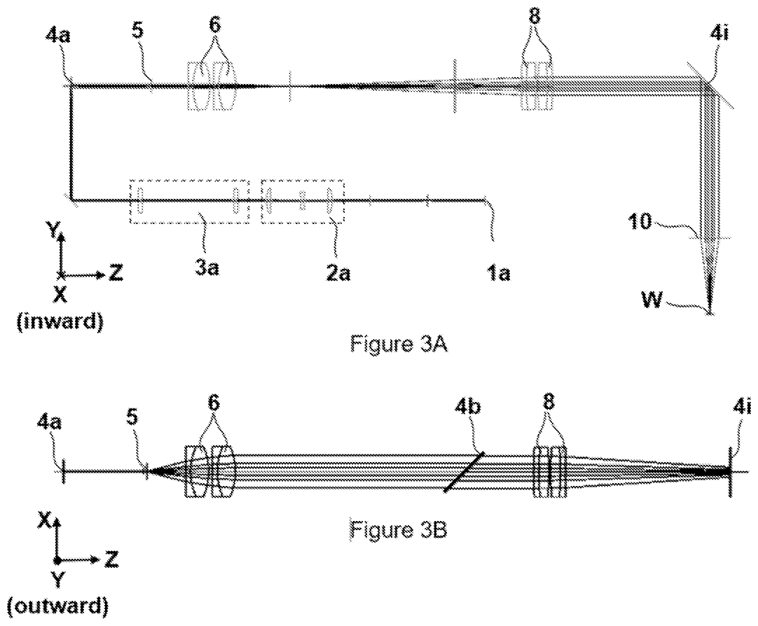

FIG. 3A shows the schematic arrangement of optical elements and an illustration of light rays in the first illumination light path of another example of the apparatus. From now on, the apparatus will be explained in relation to the coordinate system indicated in respective Figures. In the example shown in FIG. 3A, the light emitted from the first light source 1a is guided by one or more mirrors to a first symmetric beam expander 2a for symmetric expansion of the incident light beam to the same extent in every direction perpendicular to the propagation direction. Expansion of the light beam is considered to be symmetric, when entering a light beam with cylindrical symmetry into the symmetric beam expander along its optical axis results in a light beam with cylindrical symmetry exiting therefrom. The first symmetric beam expander 2a is preferably formed by two plano-convex lenses and a double-concave lens therebetween, wherein each of the curved surfaces of these lenses may be spherical. The symmetrical beam expansion ensures that the line generator 5 receives a beam with a suitable diameter for altering its intensity profile to uniform distribution. Said suitable beam diameter depends on the selected line generator 5 and is usually a function of the width of an edge, edges or other surface features of the line generator 5.

The apparatus optionally further includes a first asymmetric beam expander 3a for asymmetric expansion of the first beam, i.e., for expanding the beam to a larger extent along the Y axis than along the X axis, more preferably to expand the beam along the Y axis only and to not expand the beam along the X axis. For example, the first asymmetric beam expander 3a can be formed by two cylindrical lenses, one having one or two concave surfaces and the other having one or two convex surfaces. This asymmetric beam expansion allows the illumination of the line generator 5 along a longer section of its edge(s) and accordingly, the output of the line generator will be thicker (but still collimated) along the Y axis, allowing the illumination of a larger entry pupil of the collimator 6 and resulting in an effectively larger numeric aperture for the collimator 6 that focuses the beam along the Y axis, ultimately resulting in a thinner illuminating line that allows better imaging resolution.

Optionally, a second asymmetric beam expander (not shown in the Figures) is arranged in the second illumination light path, between the second symmetric beam expander 2b and the first illumination dichroic optical element 4a for the same purpose and operating on the same principle as the first asymmetric beam expander 3a. In some examples, the second illumination light path includes similar optical elements to that of the first illumination light path in a similar arrangement and for the sake of conciseness, it is not discussed in further detail.

In certain examples, the movement mechanism of the apparatus is suitable for moving said sample W and the optical elements of the apparatus in relation to each other linearly along the X, Y and Z axes. For instance, said movement mechanism is a so-called XYZ stage for moving said sample holder H relative to the rest of the apparatus linearly along the X, Y and Z axes. Optionally, said movement mechanism may also be suitable for rotating said sample holder H around the Y axis.

FIG. 3B shows the portion of the optical paths between the first illumination dichroic optical element 4a and the first imaging dichroic optical element 4i from the direction of the Y axis as indicated in FIG. 3A. The collimated first and second light beams are guided onto the same light path toward the line generator 5 by the first illumination dichroic optical element 4a. The line generator 5 alters the incoming light beams so that the outputted beams are diverging along the X axis, while remaining collimated along the Y axis. These beams are then collimated along the X axis and focused along the Y axis by the collimator 6. The beams obtained by the collimator 6 could be used directly or through an objective 10 for illuminating the sample W. Instead, another configuration is achieved by using a field lens 8 together with the collimator 6 so that the focal points of the collimator 6 and the field lens coincide. This way, a larger pupil of the objective is illuminated in the X direction (Z direction if the first imaging dichroic optical element deflects the light beam as shown in the Figure) allowing a tighter focus of the line, i.e. a thinner illuminating line on the sample W. At the same time, the light entering the objective 10 will be converging along the Y axis, that ensures that no light loss occurs within the objective due to vignetting and also increases the length of the line at the front focus point of the objective 10.

Throughout the present specification, the terms designating certain optical components, like “collimator”, “objective”, “field lens” or “lens” are intended to include either a single lens or an arrangement of more than one lenses, e.g., for correcting chromatic aberration or for correcting any other optical aberration. Accordingly, any one or more of the collimator 6, the field lens 8 and the objective 10 may be formed by more than one lenses. Furthermore, wherein the directions of light propagation or an arrangement of optical elements are discussed in relation to dichroic optical element, the term “toward” includes any direction of light propagation that leads to a named optical element via free propagation, reflection, refraction, diffraction or other optical interaction of the light with further optical elements, and is not restricted to an actual direct spatial direction of the named optical element.

The method includes providing a sample W, preferably a wafer, preferably on a moveable stage, producing a first light beam, expanding the first light beam, shaping the first light beam into a first line on an inspection site on a surface of the sample W, capturing, on a line of pixels, photoluminescence emitted by the sample W, scanning substantially the whole surface of said sample W with said first line, wherein shaping the first light beam into a first line is performed by using a combination of a line generator 5, a collimator 6, a field lens 8 and an objective 10, wherein collimation is performed by a pair of lenses and a further pair of lenses is used as a filed lens 8. Movement of said sample W is considered in relation to the optical elements of the apparatus and accordingly, said movement may be achieved by moving the optical elements relative to the sample W.

Said scanning can be performed by a first relative movement of said sample W and said first line at the inspection site along a first direction that forms an angle larger than 0°, preferably about 90°, with said first line on the surface of said sample W. Preferably, when a length of said first light beam is less than a linear size of said sample W, said movement in the first direction is performed by a distance larger than or equal to said linear size. Said first movement may be continuous or intermittent. Said first movement is preferably accompanied by a second movement in a direction that forms and angle of more than 0°, preferably about 90° with said first movement. Said second movement may be continuous or intermittent. Said linear size of said sample W may be for example a diameter of a circular wafer or a side length of a rectangular wafer.

In some examples, a Powell lens is used as a line generator. In certain examples, a pair of focusing lenses are used as the collimator 6 and a pair of focusing lenses are used as the field lens.

In some examples, a second light beam is produced, it is expanded symmetrically, and formed into a line that is focused on the surface onto the inspection site on the surface of the sample. Shaping the second light beam is performed by the same combination of line generator 5, collimator 6, field lens 8 and objective 10 as the first light beam, wherein a pair of achromatic lenses are used as the collimator 6 and a pair of achromatic lenses are used as the field lens 8.

Optionally, the first light beam and/or the second light beam is/are expanded asymmetrically, e.g., by a pair of cylindrical lenses, before shaping it/them into a line.

The first line and the second line has a first length and a second length respectively, wherein said first length and said second length may be smaller than the smallest linear size of said sample, e.g., smaller than the diameter of a circular wafer.

Mapping the full surface of a circular sample may be performed by arranging the sample so that the illumination line coincides a radius of the sample and scanning the sample surface by rotating a sample around its center continuously, and linearly moving it along the illumination line either intermittently thus scanning subsequent concentric annuluses in a concentric scanning pattern, or continuously thus scanning the sample surface in a spiral scanning pattern. This concentric or spiral scanning pattern may provide a shorter scanning time, i.e. better throughput for circular samples than rectangular samples. The annuluses may be subjected to suitable transformation and stitched together to form a single cartesian image. The output of the spiral scan may also be converted to a single cartesian image of the sample surface with suitable transformation. Alternatively, the detected pixel values may be stored in a polar coordinate system without conversion.

Mapping the full surface of the sample may also be performed by arranging the sample under the illumination line so that the illumination line touches the edge of the sample, moving the sample linearly in a direction perpendicular to the illumination line then moving the sample in a direction along the illumination line by a distance that is equal to or slightly less than the length of the illumination line and repeating these steps until the whole surface is mapped. The raw scanned strips may be stitched together to obtain a single image of the whole sample surface.

For each scanning pattern, the pattern can overlap itself, i.e., subsequent turns of the spiral pattern, subsequent annuluses or subsequent rectangular strips overlap each other to an extent required for reliable image stitching.

The method can further include producing a third light beam, guiding said third light beam onto the surface of said sample W, wherein said third light beam is at least partially reflected to produce a reflected third light beam, and then capturing at least a portion of said reflected third light beam to produce a reflection image of said sample. In some examples, said third light beam is guided onto the surface of said sample W through the same field lens 8 and the same objective 10 as the first light beam. In certain examples, the whole surface of the sample W is scanned by the third light beam in the same way as with the first light beam.

Though the use of the apparatus has been explained in detail in relation to semiconductor samples, and more specifically wafers, it is hereby noted, that it may be used for any kind of flat sample made of a material capable of producing photoluminescence, e.g., substrates of the flat panel display industry with or without additional layers or other microscopic structures may also be examined. Throughout the present specification, the term “wafer” is used in a broad meaning, including any kind of thin piece semiconductor material, of either doped of undoped silicon or other semiconductor material, having a circular, rectangular or other shape, either of a standard size, e.g., 300 mm, 150 mm or 75 mm, or possibly even only an irregular piece of such wafer. Accordingly, the use of the apparatus and method described here is not restricted to semiconductor wafers.

A number of embodiments are described. Other embodiments are in the following claims.

What is claimed is:

1. An apparatus for photoluminescent imaging of a sample, comprising:
a sample holder for holding said sample;
a first light source for emitting a first light beam of a cross-sectional size;
a first symmetric beam expander for expanding said first light beam;
beam shaping optics for shaping and focusing said first light beam into a line on a surface of the sample;
a first camera comprising a linear array of photodetectors for detecting photoluminescent light;
a first imaging dichroic optical element for directing the first light beam onto an objective and for directing photoluminescent light emitted by the sample to the first camera,
wherein the beam shaping optics comprise a line generator for increasing the size of the first light beam in a first direction while uniformizing an intensity distribution of said first light beam in said first direction, a collimator for collimating the first light beam along the first direction and for focusing it along a second direction perpendicular to the first direction, a field lens and the objective.

2. The apparatus according to claim 1, wherein the line generator is formed by a Powell lens.

3. The apparatus according to claim 1, wherein the collimator comprises a pair of focusing lenses, and the field lens comprises a further pair of focusing lenses.

4. The apparatus according to claim 1, wherein the apparatus further comprises:
a second light source for emitting a second light beam;
a second beam expander for expanding said second light beam; and
a first illumination dichroic optical element for guiding the first light beam and the second light beam into a common light path,
wherein the collimator comprises a pair of achromatic lenses, and the field lens comprises a pair of achromatic lenses.

5. The apparatus according to claim 4, wherein the achromatic lenses of the collimator have at least one convex surface and said achromatic lenses are arranged with their convex surfaces facing in the same direction.

6. The apparatus according to claim 4, wherein the achromatic lenses of the field lens have at least one convex surface and said achromatic lenses are arranged with their convex surfaces facing toward each another.

7. The apparatus according to claim 1, wherein an asymmetric beam expander is arranged between the first light source and the line generator, or between the second light source and the line generator, or both, wherein said asymmetric beam expander comprises a pair of cylindrical lenses.

8. The apparatus according to claim 1, wherein the apparatus further comprises a third light source, a second camera, a second illumination dichroic optical element arranged between said third light source and the objective, and a second imaging dichroic optical element arranged between the objective and said second camera.

9. The apparatus according to claim 8, wherein said third light source is a light emitting diode.

10. A method for photoluminescent imaging of a sample, comprising:
providing a sample on a sample holder;
producing a first light beam;
expanding said first light beam;
shaping the first light beam into a first line;
focusing the first light beam onto an inspection site on a surface of the sample, thereby illuminating said inspection site;
capturing, on a line of pixels, photoluminescence emitted by the sample in response to said illuminating by the first light beam;
scanning substantially the whole surface of said sample with said first line;
wherein shaping the first light beam into a first line and focusing the first light beam onto an inspection site on a surface of the sample are performed by using a combination of a line generator, a collimator, a field lens and an objective.

11. The method according to claim 10, wherein the shaping is performed by a Powell lens.

12. The method according to claim 10, wherein the collimation is performed by a pair of focusing lenses, and a pair of focusing lenses is used as the field lens.

13. The method according to claim 10, wherein the first line and the second line has a first length and a second length respectively, wherein said first length and said second length are smaller than a diameter of said sample.

14. The method according to claim 13, wherein said scanning is performed by relative movement of said sample and said first line at the inspection site in a first direction that is orthogonal to said first line and by relative movement of said sample and said first line at the inspection site in a direction that is parallel to said first line.

15. The method according to claim 14, wherein moving the sample at the inspection site along the first direction is performed by rotation of said sample around a center of said sample, and moving said sample along said second direction is performed by linear movement of said sample along a radial direction of said sample.

16. The method according to claim 14, wherein moving the sample at the inspection site along the first direction is performed by linear movement of said sample along the first direction, and moving said sample along said second direction is performed by linear movement of said sample along the second direction.

17. The method according to claim 16, wherein at least two rectangular images are constructed from the captured lines of pixels, and said rectangular images are stitched together to form a single image showing the whole sample surface.

18. The method according to claim 10, further comprising:
producing a second light beam;
expanding the second light beam; and
shaping the second light beam into a second line on the inspection site on the surface of the sample, wherein:
shaping the second light beam into said second line is performed by using the combination of the same line generator, collimator, field lens and objective as for shaping the first light beam into said first line, and
a pair of achromatic lenses is used as the collimator and a further pair of achromatic lenses is used as the field lens.

19. The method according to claim 10, further comprising:
producing a third light beam;
guiding said third light beam onto the surface of said sample, wherein said third light beam is at least partially reflected from the surface to produce a reflected third light beam; and
capturing at least a portion of said reflected third light beam.
